(19) United States
(12) Patent Application Publication
(10) Pub. No.: US 2025/0201449 A1
(43) Pub. Date: Jun. 19, 2025

(54) TWIN-CORE CABLE MANUFACTURING MACHINE AND TAPE FORMING MECHANISM THEREOF

(71) Applicant: Industrial Technology Research Institute, Hsinchu (TW)

(72) Inventors: SHIH-MING HSU, Taichung City (TW); SHOU-XI CHEN, Changhua County (TW); YU-HSIANG LIU, Changhua County (TW)

(21) Appl. No.: 18/540,963

(22) Filed: Dec. 15, 2023

(51) Int. Cl. H01B 13/00; H01B 7/22; H01B 11/00; H01B 13/26

(52) U.S. Cl. CPC H01B 13/0036; H01B 7/226; H01B 13/0016; H01B 13/26; H01B 11/002

(57) ABSTRACT

A tape forming mechanism of a twin-core cable manufacturing machine includes: a covering device, further including a fixed seat, a forming structure, and two drain-wire via sets, wherein the forming structure includes a forming part recessed on the surface of the fixed seat, the drain-wire via sets are respectively provided on the fixed seat, and each of the drain-wire via sets is respectively positioned on the two sides of the forming structure; and an eye mold structure, provided behind the covering device in a tape forming direction, and further including a forming eye mold hole area having a shape configuration. A twin-core cable manufacturing machine is also proposed.

### BACKGROUND

A cable is a component that connects two devices to transmit electrical signals; it is formed by two or more wires bonded, twisted or braided together. Cables have a wide range of uses, and each use requires special customization. The functions or the cable approximately are transmitting electrical energy, electrical signals and realizing electromagnetic energy conversion.

With the development of technologies such as the Internet of Things, cloud services, and new generation communications, cables, as one of the signal transmission channels, need to be able to support various high-frequency signal transmission applications. For this reason, twin-axial (twin-core) cables are widely used.

Generally speaking, twin-core cables have pairs of mutually insulated signal wires for transmitting differential signals. The traditional cable manufacturing process is single-core wire extrusion, and the differential pair structure is generated by paralleling the wires. Regarding the structure, the winding stage can easily cause the core wire to twist, resulting in signal delay and impedance mismatch. Furthermore, after the core wire is extruded, during the shielding coating process, the gap caused by the polymer at the bottom of the shielding layer makes the current path discontinuous, causing the insertion loss energy to rapidly attenuate and generate a resonance (suck out).

### SUMMARY

The present disclosure proposes a twin-core cable manufacturing machine and a tape forming mechanism thereof, solving the problems of resonance (suck up) and relative position instability of the signal wire and drain wire on the cross section, thereby improving the high-frequency electrical characteristics of cable products, and strengthening the protective effect of the cable outer layer and the cable's resistance to flexure and fatigue.

The present disclosure proposes a tape forming mechanism of a twin-core cable manufacturing machine, including: a covering device, including a fixed seat, a forming structure, and two drain-wire via sets, wherein the forming structure includes a forming part recessed on the surface of the fixed seat, the drain-wire via sets are respectively provided on the fixed seat, and each of the drain-wire via sets is respectively positioned on the two sides of the forming structure, and an eye mold structure, provided behind the covering device in a tape forming direction, and including a forming eye mold hole area having a shape configuration.

The present disclosure also proposes a twin-core cable manufacturing machine, including: a first Mylar (polyester) tape wrapping device, rotated and wrapping in a first rotating direction; a tape forming mechanism, connected to the first tape wrapping device; a first heating device, provided downstream of the first tape wrapping device; a second Mylar tape wrapping device, provided downstream of the first heating device, and rotated and wrapping in a second rotating direction, the second rotating direction opposite to the first rotating direction; and a second heating device, provided downstream of the second tape wrapping device.

Based on the above, the twin-cire cable manufacturing machine and tape forming mechanism of the present disclosure can solve the problems of resonance (suck out) and relative position instability of the signal wire and drain wire on the cross section through the covering device and the eye mold structure.

Furthermore, the present disclosure reveals that the twin-core cable manufacturing machine are wrapped with Mylar tape twice in forward and reverse directions and heated and fixed, which can further strengthen the strength of the outer layer of the twin-core cable against flexing and pass the fatigue test of long-term use.

In order to make the present disclosure more obvious and understandable, embodiments are given below, and detailed descriptions are given below with reference to the accompanying drawings.

### BRIEF DESCRIPTION OF THE DRAWINGS

FIG. 1 is a schematic view of a process embodiment of a twin-core cable manufacturing machine;

FIG. 2 is a schematic view of an embodiment of the tape forming mechanism of FIG. 1;

FIG. 3 is a schematic view of an embodiment of the fixture eye mold of FIG. 2;

FIG. 4 is a schematic view of one side of the eye mold structure of the present disclosure;

FIG. 5 is a schematic view of another side of the eye mold structure of the present disclosure;

FIG. 6 is a schematic view of the forming eye mold hole area in the eye mold structure of FIG. 5;

FIG. 7 is a flow chart of a manufacturing method of a twin-core cable of the present disclosure;

FIG. 8 is a schematic view of an embodiment of a co-extrusion signal wire of the present disclosure;

FIG. 9 is a schematic view of an aluminum foil wrapped twin-core cable of the present disclosure;

FIG. 10 is a schematic view of an embodiment of a first Mylar tape wrapping device of the present disclosure; and

FIG. 11 is a schematic view of an embodiment of the twin-cire cable of the present disclosure.

### DETAILED DESCRIPTION

The following embodiments are enumerated and described in detail with reference to the accompanying drawings, but the provided embodiments are not intended to limit the scope of the present disclosure. In addition, the drawings are for illustrative purposes only and are not drawn to original size. To facilitate understanding, the same elements will be identified with the same symbols in the following description.

The terms “including”, “comprising”, “having”, etc. mentioned in this disclosure are all open terms, that is, they mean “including but not limited to”.

In the description of various embodiments, when terms such as “first”, “second”, “third”, “fourth”, etc. are used to describe elements, they are only used to distinguish these elements from each other, and There is no restriction on the order or importance of these elements.

In the description of various embodiments, the so-called “coupling” or “connection” may refer to two or more elements directly making physical or electrical contact with each other, or indirectly making physical or electrical contact with each other. “Coupling” or “connection” can also refer to the mutual operation or action of two or more elements.

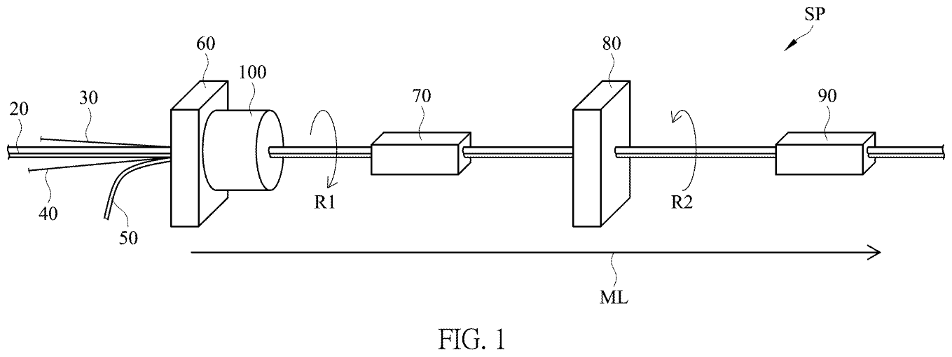

FIG. 1 is a schematic view of a process embodiment of a twin-core cable manufacturing machine of the present disclosure. Referring to FIG. 1, a twin-core cable manufacturing machine SP of the present disclosure includes a first Mylar (polyester) tape wrapping device 60, a tape forming mechanism 100 of the twin-core cable manufacturing machine, a first heating device 70, a second Mylar tape wrapping device 80, and a second heating device 90 according to the manufacturing process sequence, where along a twin-core cable manufacturing machine configuring direction ML, the first heating device 70 is provided downstream of the first Mylar tape wrapping device 60, the second Mylar tape wrapping device 80 is provided downstream of the first heating device 70, the second heating device 90 is provided downstream of the second Mylar tape wrapping device 80, where the downstream position refers to the position set according to the manufacturing process. The tape forming mechanism 100 of the twin-core manufacturing machine is connected to the first Mylar tape wrapping device 60, for example, the tape forming mechanism 100 of the twin-core cable manufacturing machine is provided inside the first Mylar tape wrapping device 60. The operation principle of the first heating device 70 and the second heating device 90 is a heating function. The first Mylar tape wrapping device 60 is a forward Mylar tape wrapping machine that rotates and wraps in a first rotating direction R1, and the second Mylar tape wrapping device 80 is a reverse Mylar tape wrapping machine that rotates and wraps in a second rotating direction R2, where the direction of the second rotating direction R2 is opposite to the direction of the first rotating direction R1. The above-mentioned Mylar tape is only an example, and the present disclosure does not limit the material of the tape used.

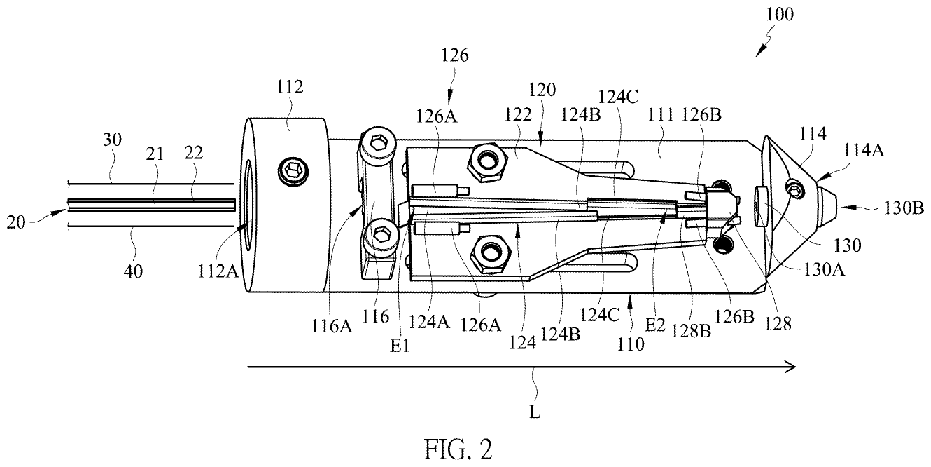

FIG. 2 is a schematic view of an embodiment of the tape forming mechanism of the twin-core cable manufacturing machine of FIG. 1. Referring to FIG. 2, the tape forming mechanism 100 of the twin-core cable manufacturing machine of the present disclosure includes a seat body 110, a covering device 120, and an eye mold structure 130. The seat body 110 includes a bearing body 111, an entrance part 112, an exit part 114, and a guide seat 116, where the bearing body 111 respectively are, for example, a flat element, and the entrance part 112 and the exit part 114 are respectively provided on the bearing body 111 and separated by a distance. The entrance part 112 is provided with an entrance 112A, the exit part 114 is also provided with an exit 114A, and the eye mold structure 130 is fixed on and protruded out from the exit 114A of the exit part 114.

In an embodiment, the guide seat 116 may be provided on the bearing body 111 and positioned between the entrance part 112 and the exit part 114; the guide seat 116 is provided with a guide port 116A, where the diameter of the entrance 112A is larger than the one of the guide port 116, and the entrance 112A, the guide port 116A and the eye mold structure 130 in the exit 114A are located at the same axial position along a tape forming direction L. furthermore, the guide seat 116 is adjacent to the entrance part 112, namely, the distance between the guide seat 116 and the entrance part 112 is smaller than the one between the guide seat 116 and the entrance part 114. However, the configuration position of the guide seat 116 may be determined depending on the actual situation.

The covering device 120 includes a fixed seat 122, a forming structure 124, two drain-wire through-hole sets 126, and a fixture eye mold 128. The shape of the fixed set 122 is, for example, a wing-like panel, which may be fixed on the bearing body 111, and the fixed seat 122 is positioned between the entrance part 112 and the exit part 114, and adjacent to the guide seat 116.

The forming structure 124 is provided on the center of the fixed seat 122, and includes a forming part 124A, a pressing plate part 124B, and an upright plate part 124C, where the forming part 124A is, for example, a groove, and recessed on the surface of the fixed seat 122. Furthermore, the forming part 124A includes an entrance end E1 and an exit end E2 opposite to each other, where the entrance end E1 is adjacent to the guide seat 116, and the exit end E2 to the fixture eye mold 128. The diameter of the entrance 112A and the one of the guide port 116A respectively are larger than the one of the entrance end E1 of the forming part 124A. Furthermore, along the tape forming direction L, the diameter of the entrance end E1 of the forming part 124A is larger than the one of the exit end E2, namely, the groove of the forming part 124A is tapered.

The pressing plate part 124B and the upright plate part 124C respectively are flat elements, as shown in FIG. 2. The pressing plate part 124B and the upright plate part 124C are respectively provided on the forming part 124A, and the pressing plate part 124B is adjacent to the upright plate part 124C, where from the entrance end E1 of the forming part 124A to a position of the forming part 124A is provided with the pressing plate part 124B shielding or partly shielding the forming part 124A, facilitating forming and squeezing of an element within the forming part 124A; and form the end of the pressing plate part 124B of the forming part 124A to the exit end E2 of the forming part 124A is provided with the upright plate part 124C, and the upright plate part 124C can be a plate formed by vertically extending the wall surface of the forming part 124A without shielding the forming part 124A. However, the present disclosure does not limit the type of the forming structure 124, and it can be adjusted according to the actual type of an element to be tape-formed.

The drain-wire through-hole set 126 is a through hole, and each drain-wire through-hole set 126 includes a first drain-wire via 126A, and a second drain-wire via 126B in sequence along the tape-forming direction L, where one of the two first drain-wire vias 126A is respectively provided on the two sides of the forming part 124A, and one end of the first drain-wire via 126A is positioned on the entrance end E1 of the forming part 124A; the diameter of the entrance 112A and the one of the guide port 116A are respectively larger than the sum of the size of the entrance E1 of the forming part 124A and the diameters of the two first drain-wire vias 126.

The fixture eye mold 128 is connected to the end of the fixed set 122, and the two second drain-wire vias 126B are connected to the fixture eye mold 128, the two second drain-wire vias 126B are respectively positioned outside the exit end E2 of the forming part 124, and the positions of the two second drain-wire vias 126B correspond to the positions of the corresponding first drain-wire vias 126A.

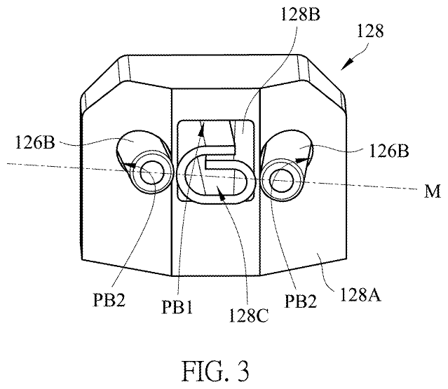

FIG. 3 is a schematic view of an embodiment of the fixture eye mold of FIG. 2. Referring to FIGS. 2 and 3, the fixture eye mold 128 includes a fixture body 128A, a forming channel 128B, and a through hole 128C, where the fixture body 128A includes a first accommodating hole PB1, two second accommodating holes PB2 positioned on the two sides of the first accommodating hole PB1. In an embodiment, the first accommodating hole PB1, for example, rectangular, and the second accommodating hole PB2 is, for example, circular. The forming channel 128 is, for example, two sheets wound and bent to form the through hole 128C. The forming channel 1128B is passed through the first accommodating hole PB1, and the two second drain-wire vias 126B are respectively passed through the corresponding second accommodating hole PB2, allowing the second drain-wire via 126 and forming channel 128B to be arranged along a straight line M that may be an imaginary line that passes through the center of the second drain-wire t 126B and the center of the forming channel 128B at the same time, namely, the second drain-wire via 126B and the forming channel 128B can be substantially aligned with each other and arranged on an imaginary line.

The two second drain-wire via 126B are respectively inclined an angle toward the adjacent forming channel 128B, allowing the two second drain-wire vias 126B to respectively face the axial direction of the through hole 128C.

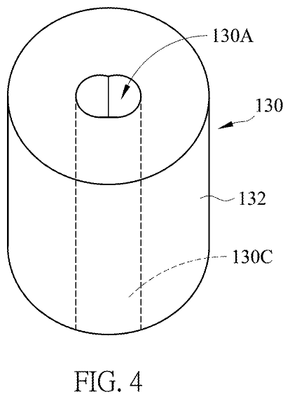

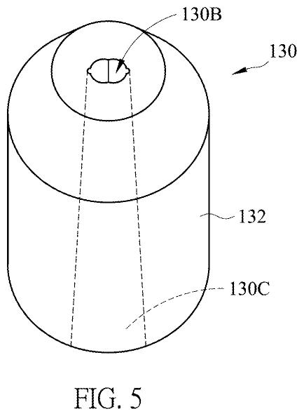

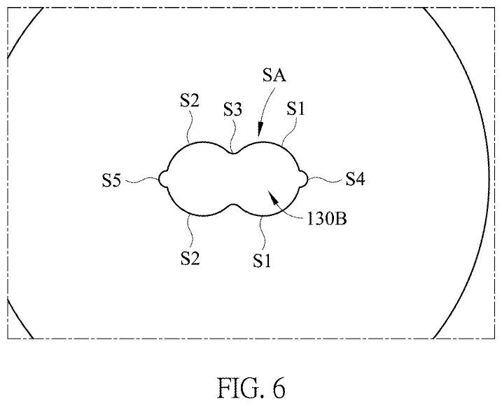

FIG. 4 is a schematic view of one side of the eye mold structure of the present disclosure. FIG. 5 is a schematic view of the other side of the eye mold structure of the present disclosure. FIG. 6 is a schematic view of a forming eye-mold hole area in the eye mold structure of FIG. 5. Referring to FIGS. 2 and 4 to 6, the eye mold structure 130 is provided behind the covering device 120 in a tape forming direction L, and fixed on and protruded out from the exit 114A of the exit part 114. The eye mold structure 130 includes a cylinder 132, an eye mold entrance area 130A, a forming eye mold hole area 130B, and an eye mold channel 130C, where the cylinder 132 is, for example, a circular cylinder; the eye mold entrance area 130A is provided on one side of the cylinder 132, and adjacent to the fixture eye mold 128 and faces the forming channel 128B and the second drain-wire via 126B; the forming eye mold hole area 130B is provided on another side of the cylinder 132, and the eye mold channel 130C is positioned between the eye mold entrance area 130A and the forming eye mold hole area 130B.

In the present embodiment, the forming eye mold hole area 130B, as shown in FIG. 6, has a shape configuration SA, the appearance of which may be adjusted according to the product of the desired process. In the present embodiment, the shape configuration SA includes two first arcs S1, two second arcs S2, a third arc S4, and a fourth arc S5, where one of the first arcs S1 is connected to the second arc S2 with a handover S3, and the other first arc S1 is connected to the corresponding second arc S2; the two first arcs S1 are formed into an approximately circular shape, the two second arcs S2 are formed into an approximately circular shape, and the radiuses thereof may be determined according to an actual product. The two ends of the third arc S4 are respectively connected to the corresponding first arcs S1, and the two ends of the fourth arcs S5 are respectively connected to the corresponding second arcs S2, allowing the third arc S4 and the fourth arc S5 to respectively be the left and the right sides of the shape configuration SA, where the sizes of the third arc S4 and the fourth arc S5 are also determined according to an actual product.

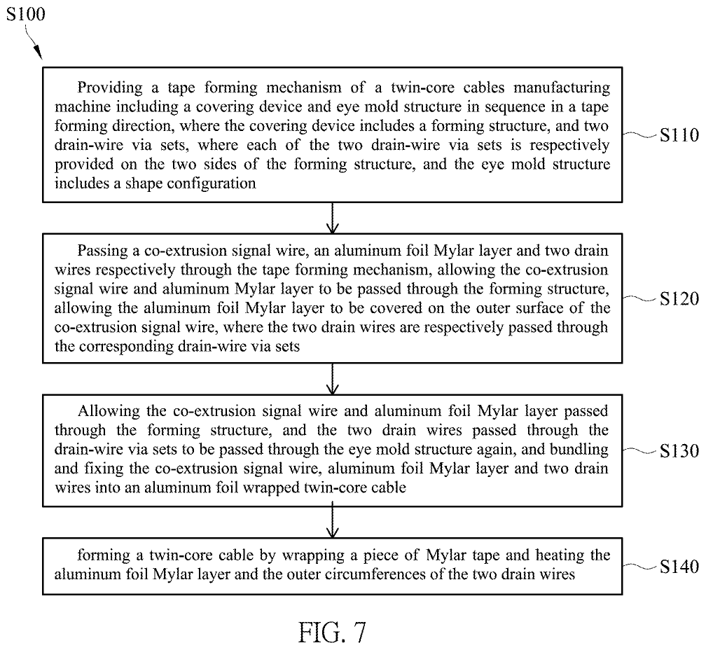

FIG. 7 is a schematic flow chart of the manufacturing method of a twin-core cable of the present disclosure. Referring to FIG. 7, the manufacturing method S100 of the twin-core cable of the present disclosure includes the following steps S11 to S14.

First, go to the step S110, providing a tape forming mechanism 100 of the twin-core cable manufacturing machine as shown in FIGS. 1 and 2. The tape forming mechanism 100 of the twin-core cable manufacturing machine includes a covering device 120 and an eye mold structure 130 in sequence in a tape forming direction L, where the covering device 120 includes a forming structure 124, and two drain-wire through-hole sets 126, where each of the two drain-wire through-hole sets 126 is respectively provided on the two sides of the forming structure 124. The eye mold structure 130 includes a shape configuration SA.

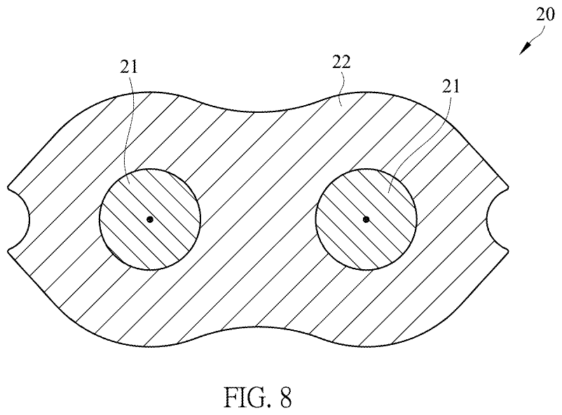

Taking FIG. 1 as an example, a co-extrusion signal wire 20, two drain wires 30, 40, and an aluminum foil Mylar layer 50 are placed into the twin-core cable manufacturing machine, where the co-extrusion signal wire 20 includes two signal wires 21, and an insulation material part 22, as shown in FIG. 8. In an embodiment, the insulation material part 22 is covered outside the two signal wires 21 by means of co-extrusion, which can prevent the signal wire 21 from exposure, and fix the relative position of the two signal wires 21. The diameter of the signal wire 40 may be, for example, 0.12 mm, and the two drain wires 30, 40 respectively are, for example, a tinned copper wire.

Next, go to the step S120, respectively passing the co-extrusion signal wire 20, the aluminum foil Mylar layer 50 and two drain wires 30, 40 through the tape forming mechanism 100 of the twin-core cable manufacturing machine, allowing the co-extrusion signal wire 20 and the aluminum foil Mylar layer 50 to be passed through the forming structure 124, so that the two drain wires 30, 40 are respectively passed through the corresponding drain-wire through-hole sets 120.

As FIG. 2 shows, the co-extrusion signal wire 20 and the aluminum foil Mylar layer 50 are passed through the entrance 112A in the entrance part 112, the guide port 116A in the guide seat 116, and the forming part 124A in the forming structure 124 in sequence. While passing through the forming part 124A, the co-extrusion signal wire 20 and the aluminum foil Mylar layer 50 are squeezed and fixed through the pressing plate part 123B in advance, allowing the aluminum foil Mylar layer 50 to be directly covered on the outer surface of the co-extrusion signal wire 20, where the overlap width thereof is about 1 to 2 mm, which makes sure that the gap will not happen, thereby reducing the gap caused by covering the aluminum foil Mylar layer 50 on the co-extrusion signal wire 20 to make the current path discontinuous. Therefore, the inconsistency in performance of the extruded co-extruded signal wire 20 can be eliminated, and the shielding covering structure of the aluminum foil Mylar layer 50 is consistent, making it difficult for signals to leak, and further improving the completeness of transmission line signals. Thereafter, the co-extrusion signal wire 20 covered with the aluminum foil Mylar layer 50 is allowed to be passed through the upright plate part 124C, and then passed through the fixture eye mold 128.

In addition, in an embodiment, the aluminum foil Mylar layer 50 and the co-extrusion signal wire 20 are allowed to be passed through the entrance end E1 and the exit end E2 in the forming part 124A in sequence, where the hole diameter of the entrance end E1 is larger than the one of the exit end E2. The groove passed through the forming part 124A is tapered, allowing the passed-through aluminum foil Mylar layer 50 to be more tightly attached to and covered on the outer surface of the co-extrusion signal wire 20. At the same time, the two drain wires 30, 40 are respectively passed through the entrance 112A in the entrance part 112, the guide port 116A in the guide seat 116, and the first drain-wire via 126A and the second drain-wire via 126B in the corresponding drain-wire via set 126 in sequence, and thereafter, passed through the fixture eye mold 128 again. Since the two drain-wire via sets 126 are respectively positioned on the two sides of the forming part 124A, during the above-mentioned passing process, in addition to covering the outer surface of the co-extrusion signal wire 20 with the aluminum foil Mylar layer 50, the two drain wires 30, 40 can also be limited to the two opposite sides of the co-extrusion signal wire that has been covered with the aluminum foil Mylar layer 50.

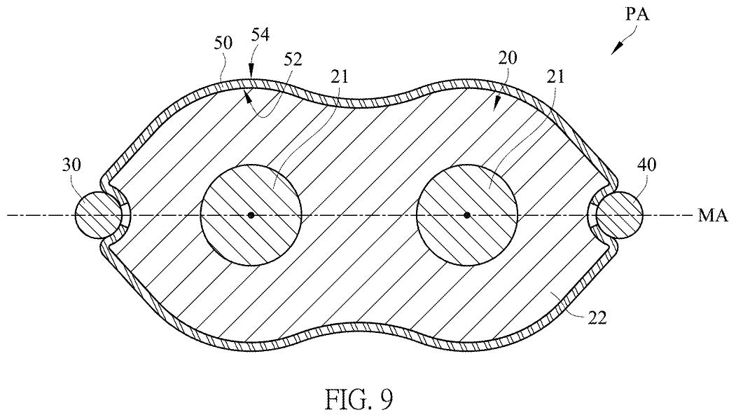

Next, go to the step S130, allowing the co-extrusion signal wire 20 and the aluminum foil Mylar layer 50 passed through the forming structure 124, and the two drain wires 30, 40 passed through the drain-wire via sets 120 to be respectively passed through the eye mold structure 130 again, and bundling and fixing the co-extrusion signal wire 20, the aluminum foil Mylar layer 50 and the two drain wires 30, 40 into an aluminum foil-wrapped twin-core cable PA according to the shape configuration SA of the eye mold structure 130 (shown in FIG. 6), as FIG. 9 shows.

As FIG. 6 shows, according to the shape configuration SA of the eye mold structure 130, the co-extrusion signal wire 20, the aluminum foil Mylar layer 50 and the two drain wires 30, 40 are pulled out through the eye mold structure 130 by the accurate shape configuration SA, making sure that the passed-through of the co-extrusion signal wire 20, the aluminum foil Mylar layer 50 and the two drain wires 30, 40 can be consistent with the corresponding shape of the shape configuration SA, and the positions of the two signal wires 21 are controlled, preventing the two signal wires 21 from being affected by the shrinkage of the covering material due to the aluminum foil Mylar layer 50. As FIG. 9 shows, the aluminum foil Mylar layer 50 is covered on the outer surface of the co-extrusion signal wire 20, and the aluminum foil Mylar layer 50 is formed to be a similar shape by the first arc S1 and the second arc S2 in the corresponding shape of the shape configuration SA shown in FIG. 6, and the gap between the aluminum foil Mylar layer 50 and the co-extrusion signal wire 20 is further decreased, so that they can be tightly attached to each other, where an insulating surface 52 of the aluminum foil Mylar layer 50 is in contact with the co-extrusion signal wire 20, and a conducting surface 54 of the aluminum foil Mylar layer 50 faces outward.

The insulting surface 52 is made of, for example, plastics, and the conducting surface 54 is made of, for example, aluminum.

On the other hand, the positions of the two drain wires 30, 40 will be fixed due to the correspondingly shaped third arc S4 and the fourth arc S5 in the shape configuration SA, allowing the two drain wires 30, 40 to be respectively positioned on the two opposite sides of the aluminum foil Mylar layer 50, and allowing the two drain wires 30, 40, the aluminum Mylar layer 50, and the two signal wires 21 to be arranged along a straight line MA, which may be, for example, an imaginary line passing through the center of the two drain wires 30, 40 and the center of the two signal wires 21 at the same time, namely, the two drain wires 30, 40 and the two signal wires 21 can be substantially aligned with each other and arranged on an imaginary straight line.

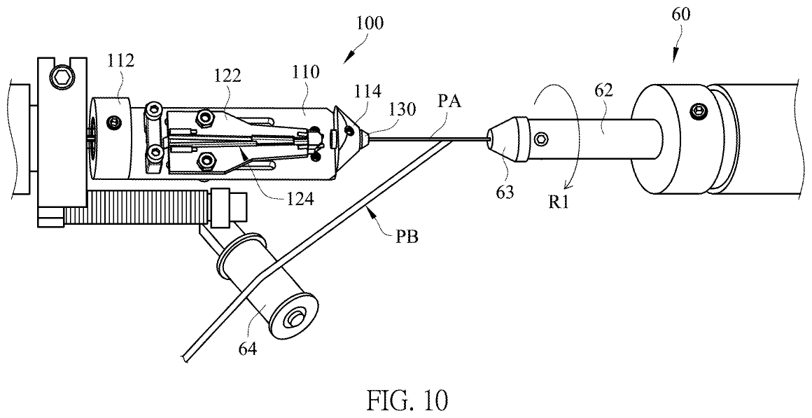

Next, go to the step S140 and coordinate with FIGS. 10 and 1, forming a twin-core cable PC by wrapping a piece of Mylar tape PB and heating the outer circumference of the twin-core cable PA wrapped with aluminum foil.

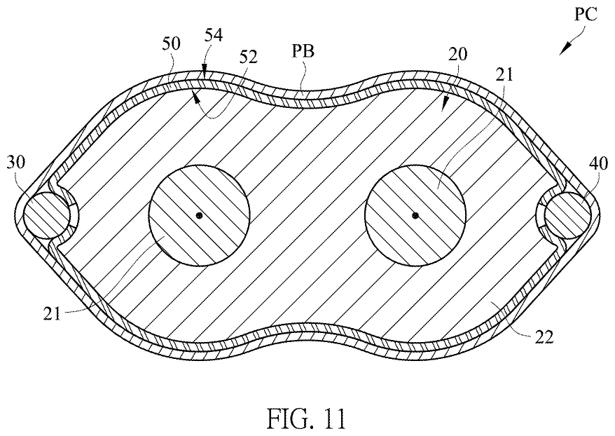

As FIG. 10 shows, the first Mylar tape wrapping device 60 includes a wrapping rotating shaft 62, a wrapping eye mold 63, and a tension roller 64, where the wrapping rotating shaft 62 is connected to the wrapping eye mold 63 and can drive it to rotate toward a direction (such as first rotating direction R1). Therefore, the aluminum foil wrapped twin-core cable PA formed after passed through the eye mold structure 130, and a Mylar tape (PE) are transferred inside the wrapping eye mold 63, and the wrapping eye mold 63 is driven to rotate by the wrapping rotating shaft 62, allowing the Mylar tape PB to be rotated around and cover the outer side of the aluminum foil wrapped twin-core cable PA. The Mylar tape PB and the aluminum foil wrapped twin-core cable PA passed through the wrapping rotating shaft 62 are formed into the twin-core cable PC as shown in FIG. 11. In addition, the Mylar tape PB can be transferred to a specific position through the tension roller 64 or other transferring element with similar functions.

Thereafter, as FIG. 1 shows, the twin-core cable PC is transferred to the first heating device 70, and the twin-core cable PC is heated; next, the twin-core cable PC passed through the firs heating device 70 is further passed through the second Mylar tape wrapping device 80 to perform the wrapping action of the Mylar tape PB once more; the second Mylar tape wrapping device 80 has the same structures as the wrapping rotating shaft 62, the wrapping eye mold 63 and the tension roller 64 of the above first Mylar tape wrapping device 60, and the difference from the above first Mylar tape wrapping device 60 is the twin-core cable PD is performed with the wrapping action in the second rotating direction P2, in other words, the Mylar tape PB is wrapped twice in different rotating directions. Finally, the twin-core cable PC is further heated by the second heating device 90. It can be seen from this that the twin-core cable manufacturing machine SP of the present disclosure can further strengthen the strength of the outer layer of the twin-core cable PC to resist deflection through two Mylar tape wrapping of forward and reverse directions and heating fixation, and can pass the long-term use fatigue testing.

To sum up, the disclosed twin-cire cable manufacturing machine and tape forming mechanism can solve the problems of resonance and relative position instability of the signal wire and drain wire on the cross section through the covering device and eye mold structure.

Furthermore, the present disclosure reveals that the twin-core cable manufacturing machine are wrapped with Mylar tape twice in forward and reverse directions and heated and fixed, which can further strengthen the strength of the outer layer of the twin-core cable against flexing and pass the fatigue test of long-term use.

Although present disclosure has been disclosed in embodiments, it is not intended to limit present disclosure. Any person with common knowledge in the technical field may make slight modifications and embellishments within the spirit and scope of this disclosure, and therefore the scope of protection of present disclosure shall be subject to the scope defined in the attached patent application.

What is claimed is:

1. A tape forming mechanism of a twin-core cable manufacturing machine, comprising:
a covering device, further comprising a fixed seat, a forming structure, and two drain-wire via sets, wherein said forming structure comprises a forming part recessed on the surface of said fixed seat, said drain-wire via sets are respectively provided on said fixed seat, and each of said drain-wire via sets is respectively positioned on the two sides of said forming structure; and
an eye mold structure, provided behind said covering device in a tape forming direction, and further comprising a forming eye mold hole area having a shape configuration.

2. The mechanism according to claim 1, wherein said forming structure comprises a pressing plate part provided on said forming part, and shielding or partly shielding said forming part.

3. The mechanism according to claim 1, wherein said forming part comprises an entrance end and an exit end opposite to each other, and the hole diameter of said entrance end is larger than the one of said exit end.

4. The mechanism according to claim 1, further comprising:
a seat body, comprising a bearing body, an entrance part, and an exit part, wherein said entrance part and said exit part are respectively provided on said bearing body and separated apart by a distance, said fixed seat is fixed on said bearing body, said fixed seat is positioned between said entrance part and said exit part, said entrance part is provided with an entrance, said exit part with an exit, and said eye mold structure is fixed on and protruded out from said exit of said exit part.

5. The mechanism according to claim 4, wherein said seat body further comprises a guide seat positioned between said entrance part and said exit part, and adjacent to said entrance part, said fixed seat is adjacent to said guide seat, said guide seat is provided with a guide port, and said entrance, said guide port, and said eye mold structure in said exit are located on the same axial position along said tape forming direction.

6. A twin-core cable manufacturing machine, comprising:
a first tape wrapping device, configured to rotate a tape to wrap over a cable in a first rotating direction;
a tape forming mechanism according to claim 1, connected to said first tape wrapping device;
a first heating device, provided downstream of said first tape wrapping device to heat said cable;
a second tape wrapping device, provided downstream of said first heating device, and configured to rotate a tape to wrap over said cable in a second rotating direction, said second rotating direction opposite to said first rotating direction; and
a second heating device, provided downstream of said second tape wrapping device to heat said cable.
